(19) United States
(12) Patent Application Publication
(10) Pub. No.: US 2024/0402641 A1
(43) Pub. Date: Dec. 5, 2024

(54) CONTROL OF COPY TIME BY ADJUSTING PAPER FEED TIME

(71) Applicant: Hewlett-Packard Development Company, L.P., Spring, TX (US)

(72) Inventors: Jungwoo SON, Seongnam-si (KR); Uichoon LEE, Seongnam-si (KR); Byoungil LEE, Seongnam-si (KR)

(21) Appl. No.: 18/692,619

(22) PCT Filed: Mar. 2, 2022
(86) PCT No.: PCT/US2022/018438

§ 371 Date: Mar. 15, 2024

(30) Foreign Application Priority Data
Sep. 16, 2021 (KR) 10-2021-0124035

(51) Int. Cl. G03G 15/00; G03G 15/20

(52) U.S. Cl. CPC G03G 15/6511; G03G 15/2003; G03G 15/6529

(57) ABSTRACT

An example image forming apparatus may include an image forming part, a paper feeding part to transfer a printing paper to the image forming part, a scanning part, and a processor which, based on a copying instruction of a document being input, is to control the scanning part to initiate scanning for the document to be copied, and control the paper feeding part to initiate transfer of the printing paper before the scanning is completed.

### BACKGROUND

An image forming apparatus refers to an apparatus which prints printing data generated in a terminal apparatus like a computer on a printing medium such as paper. As examples of such an image forming apparatus, there may be copiers, printers, facsimiles, scanners, or multi-function peripherals (MFPs) which multiply implement functions of the aforementioned apparatuses through one apparatus, etc.

### BRIEF DESCRIPTION OF THE DRAWINGS

Various examples will be described below by referring to the following figures.

FIG. 1 is a block diagram illustrating an image forming apparatus according to an example;

FIG. 2 is a block diagram illustrating an image forming apparatus according to an example;

FIG. 3 is a diagram illustrating a driving timing of components of an image forming apparatus;

FIG. 4 is a diagram illustrating a driving timing of components of an image forming apparatus according to an example;

FIG. 5 is a flow chart illustrating a processing method of a document of an image forming apparatus according to an example;

FIG. 6 to FIG. 9 are flow charts illustrating a processing method of a document of an image forming apparatus according to various examples; and

FIG. 10 is a diagram illustrating instructions stored in a non-transitory computer-readable recording medium according to an example.

### DETAILED DESCRIPTION

Examples that will be described below are to promote an understanding of the disclosure. However, the disclosure may be implemented while being modified in various forms, unlike the examples described herein.

As terms used in this specification and the claims, general terms were selected in consideration of the functions described in the disclosure. However, the terms may vary depending on an intention, a legal or technical interpretation, or an emergence of a new technology.

In addition, in some cases, there may be terms that were arbitrarily designated by the applicant, and the meaning of such terms may be interpreted as defined in this specification, and if there is no specific definition of the terms, the terms may be interpreted based on the overall content of this specification.

Further, in this specification, elements used for explanation of each example of the disclosure are described, but elements are not limited thereto. Accordingly, some elements may be changed or omitted, or other elements may be added. Also, elements may be arranged to be dispersed in apparatuses independent from one another.

In this specification, a description that one element is “connected to” another element should be interpreted to include both the case where the one element is directly connected to the other element, and the case where the one element is connected to the other element through still another element. Also, a description that an element “includes” another element does not indicate that other elements are excluded, but rather that other elements may be further included, unless there is any specific description meaning the contrary.

In this specification, the order of each operation should be understood in a nonrestrictive way, unless a preceding operation is described as needing to be performed prior to a subsequent operation in a logical and temporal sense. That is, excluding an exceptional case as above, even if a process described as a subsequent operation is performed prior to a process described as a preceding operation, there would be no influence on the essence of the disclosure, and the scope of the disclosure should also be defined regardless of the orders of operations.

Hereinafter, examples of the disclosure will be described with reference to the accompanying drawings and the contents described in the accompanying drawings, but the disclosure is not restricted or limited by the examples.

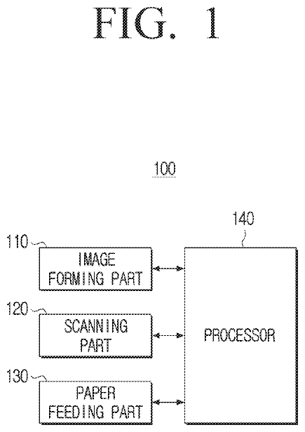

FIG. 1 is a block diagram illustrating an image forming apparatus according to an example.

Referring to FIG. 1, an image forming apparatus 100 includes an image forming part 110, a scanning part 120, a paper feeding part 130, and a processor 140.

The image forming apparatus 100 may be an apparatus that can perform various kinds of image forming jobs. As examples of such an image forming apparatus, there may be copiers, printers, facsimiles, scanners, or multi-function peripherals (MFPs) which multiply implement functions of the aforementioned apparatuses through one apparatus, etc., but the disclosure is not limited thereto.

In this specification, “an image forming job” may refer to any of various kinds of jobs related to an image such as formation of an image or generation/storing/transmission of an image file, etc. (e.g., copying, printing, scanning, or faxing), and “a job” may refer to an image forming job, and may also include any of a series of processes for performing an image forming job.

Also, in this specification, “a user” may refer to a person who performs a manipulation related to an image forming job by using an image forming apparatus or a device connected with the image forming apparatus via wire or wirelessly.

The image forming part 110 is to perform an image forming job, and it may perform at least one process among processes of the image forming job.

Processes of an image forming job may include a charging process of charging a photosensitive body, an exposure process of forming a latent image on the photosensitive body, a developing process of developing the latent image into an image, a transfer process of transferring the image to a printing medium, and a fixing process of fixing the image transferred to the printing medium, but the disclosure is not limited thereto.

The scanning part 120 may irradiate a light on a document, receive a reflected light, and read an image recorded on the document. As an image sensor that reads an image from a document, a charge coupled device (CCD), a contact type image sensor (CIS), etc. may be adopted, for example. The scanning part 120 may have a flatbed structure wherein a document is located in a fixed location, and an image is read as an image sensor moves, a document feed structure wherein an image sensor is located in a fixed location and a document is transferred, and a combined structure thereof.

The scanning part 120 may perform scanning of a document in units of strips, and as a size of the document increases, scanning of more strips may be performed. As an example, regarding a paper having an A4 size, scanning may be performed using as many as 38 strips to scan the entire paper.

The paper feeding part 130 is to transfer a printing medium (e.g., a paper) to a location wherein an image forming job is performed so that the image forming part 110 can perform the image forming job, and it may control transfer of a paper during an image forming job.

As an example, the paper feeding part 130 may perform transfer of a printing paper from a tray wherein printing papers are loaded to a location wherein a transfer job is performed in the image forming part 110, but the disclosure is not limited thereto.

The processor 140 may control an operation of the image forming apparatus 100 according to various examples of the disclosure. The processor 140 may be implemented as a central processing unit (CPU), an application-specific integrated circuit (ASIC), a System on Chip (SoC), etc., but the disclosure is not limited thereto.

The processor 140 may perform various operations based on data or instructions stored in the memory 150. For example, the processor 140 may execute a program stored in the memory 150, read a file stored in the memory 150, or store a new file in the memory 150.

If a copying instruction is input, the processor 140 may control the scanning part 120 and perform a scanning job for a document to be copied, and control the paper feeding part 130 and transfer a printing paper to the image forming part 110 to print the scanned document.

A copying instruction may be directly input through a user interface provided in the image forming apparatus itself, or it may be input through a terminal apparatus connected to the image forming apparatus.

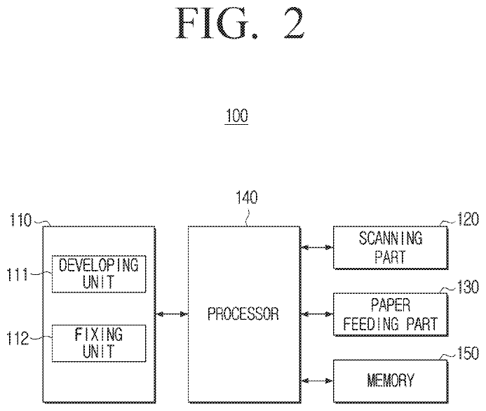

FIG. 2 is a block diagram illustrating an image forming apparatus according to an example.

Referring to FIG. 2, the image forming apparatus 100 includes the image forming part 110, the scanning part 120, the paper feeding part 130, the processor 140, and a memory 150.

It is illustrated that the image forming part 110 includes a developing unit 111 and a fixing unit 112. However, other components may be further included depending on needs or implementation. For example, a charging unit, an exposure unit, a transfer unit, etc. may be further included.

The developing unit 111 is to perform a developing process of developing a latent image into an image, and it may include a photosensitive body and a developing device.

The photosensitive body may be referred to as a photosensitive drum, a photosensitive belt, etc. according to the form, and the charging unit may charge the surface of the photosensitive body with a uniform potential.

The exposure unit may change the surface potential of the photosensitive body according to information of an image to be printed, and thereby form an electrostatic latent image on the surface of the photosensitive body. As an example, the exposure unit may form an electrostatic latent image by irradiating a modulated light on the photosensitive body according to information of an image to be printed, and drive an exposure motor at a constant speed to form a latent image on the photosensitive body.

The developing device is to receive and accommodate (e.g., store) a developing agent and provide the developing agent to the electrostatic latent image to develop the electrostatic latent image into a visual image. The developing device may include a developing roller to provide the developing agent to the electrostatic latent image. As an example, the developing agent may be provided from the developing roller to the electrostatic latent image formed on the photosensitive body by an electric developing field formed between the developing roller and the photosensitive body.

The visual image formed on the photosensitive body may be transferred to a printing paper by the transfer unit. As an example, the transfer unit may transfer the visual image to a printing paper by an electrostatic transfer method.

The fixing unit 112 is to perform a fixing process of fixing the image transferred to the printing paper by the transfer unit. In an example, the fixing unit 112 may fix the visual image on the printing paper by applying heat and/or pressure to the visual image.

The fixing unit 112 may include a heat source to fix the visual image transferred to the printing paper. In an example, the fixing unit 112 may raise the temperature of the heat source to perform the fixing process.

The aforementioned developing agent may be used whenever an image forming job proceeds. In that case, the developing agent may be depleted based on being used for more than a certain number of image forming jobs. In a situation in which the developing agent is depleted, the developing device itself, which is a unit to store the developing agent, may be newly replaced.

The memory 150 is to store various kinds of data and programs for an operation of the image forming apparatus 100.

The memory 150 may be implemented as a storage medium inside the image forming apparatus 100, e.g., a hard disk drive (HDD), a solid state drive (SDD), etc. or implemented as an external storage medium, e.g., a removable disk including a universal serial bus (USB) memory, a web server through a network, etc. The memory 150 may store at least one data or instruction for the various examples of the disclosure.

The memory 150 may store in advance a size of a document to be scanned before performing scanning in the scanning part 120, and may store in advance a size of the paper on which an image forming job will be performed, the number of the tray (e.g., location) at which the paper is provided, etc.

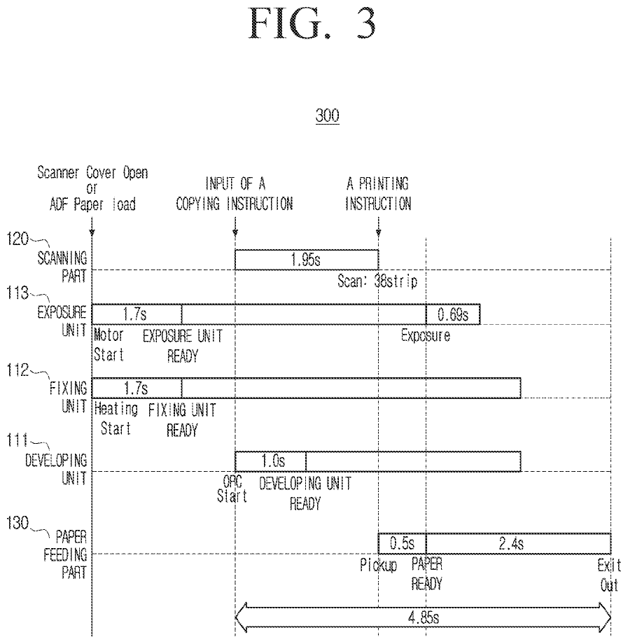

FIG. 3 is a block diagram illustrating a driving timing 300 of components in an image forming apparatus.

In case a user opens a cover of a scanner of the image forming apparatus 100 or loads documents on an automatic document feeder (ADF) as a pre-operation for performing a copying instruction of a document in the image forming apparatus 100, an exposure unit 113 and the fixing unit 112 may initiate driving. However, the disclosure is not limited thereto, and driving may be initiated as power is applied to the image forming apparatus 100 or by a separate manipulation of the user.

The exposure unit 113 includes an exposure motor. Based on the exposure motor reaching a speed at which an exposure process can be performed, the exposure unit 113 enters a ready state. However, the disclosure is not limited thereto, and the exposure unit 113 may enter a ready state based on the exposure unit 113 entering a state of being able to perform an exposure process.

Based on driving being initiated, the fixing unit 112 may start to raise the temperature of the heat source for fixing a visual image on a printing paper, and, based on a temperature at which a fixing process can be performed being reached, the fixing unit 112 enters a ready state. However, the disclosure is not limited thereto, and the fixing unit 112 may enter a ready state based on the fixing unit 112 entering a state of being able to perform a fixing process.

If a copying instruction is input into the image forming apparatus 100, the processor 140 may control the scanning part 120 to initiate scanning for a document, and initiate driving of the developing unit 111 to perform the image forming job.

According to an example, scanning as many as 38 strips may be performed to scan an entire document in an A4 size, and a time of 1.95 seconds may be spent to complete the scanning. The time spent for the scanning may be a time including the time that the scanning part 120 prepares driving and the time of reading the image.

According to an example, based on the driving of the developing unit 111 being initiated, the driving of the photosensitive body (e.g., the OPC) included in the developing unit may be initiated, and a time of 1 second may be spent to reach the ready state of the developing unit 111 that reached a constant driving and a state of maintaining a specific high pressure.

The lifespan of the developing unit 111 decreases during the driving, and the lifespan also decreases during an idling without performing a developing process.

The paper feeding part 130 may perform a transfer of a printing paper from the tray wherein printing papers are loaded to a location wherein the image forming job starts. Based on the transfer of the printing paper to the location wherein the image forming job starts being completed, the paper feeding part 130 becomes a paper ready state. According to an example, a time of 0.5 seconds may be spent from the start of the transfer of the paper to reach the paper ready state.

Based on entering the ready state of the developing unit 111, the ready state of the fixing unit 112, the ready state of the exposure unit 113, and the paper ready state of the paper feeding part 130, the exposure unit 113 may start an exposure process and perform the image forming job of the scanned document.

A printing instruction may include information for an image forming job. According to an example, a printing instruction may include a size of a scanned document, a size of a paper to be printed, a tray number of a printing paper, image data of the scanned document, etc., but the disclosure is not limited thereto.

In a previous example, based on scanning of a document by the scanning part 120 being completed, the processor 140 may input a printing instruction into the image forming part 110, and transfer of a printing paper by the paper feeding part 130 may be started.

In this case, even though scanning was completed and a printing instruction was input into the image forming part 110, it took time until reaching the paper ready state of the paper feeding part 130, and thus an exposure process could not be performed immediately. Accordingly, a substantial start of the image forming job became late.

According to an example, a time of 2.4 seconds may be spent for the image forming job to be performed after the transfer of the printing paper is completed, and in this case, a time of 4.85 seconds may be spent from the input of the copying instruction to the completion of the image forming job and the outputting of the paper.

Also, a lifespan of the developing unit 111 may be consumed even in a state of idling. In case the driving of the developing unit 111 is initiated at the same time as the inputting of the copying instruction, the idling state should be maintained until the image forming job starts even though the developing unit 111 entered a ready state, and thus the actual lifespan becomes shorter than the expected lifespan.

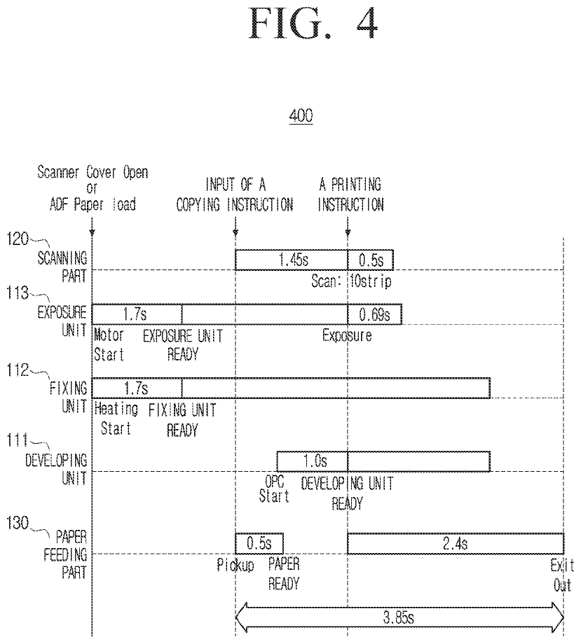

FIG. 4 is a diagram illustrating a driving timing 400 of components of an image forming apparatus according to an example.

As described above, in case a user opens the cover of the scanner or loads documents on the automatic document feeder as a pre-operation to perform a copying instruction of a document in the image forming apparatus 100, the exposure unit 113 and the fixing unit 112 may initiate driving.

Based on a copying instruction being input into the image forming apparatus 100, the processor 140 may control the scanning part 120 to initiate scanning for the document, and may control the paper feeding part 130 to initiate transfer of a printing paper at the same time or sequentially.

The processor 140 may control the paper feeding part 130 to initiate the transfer of the printing paper before the scanning of the document is completed, and the scanning of the document and the transfer of the paper may be performed at the same time.

According to an example, based on a copying instruction being input, the driving of the paper feeding part 130 may be initiated at the same time as initiating the driving of the scanning part 120.

As a noise may be generated based on the paper feeding part 130 starting the transfer of the printing paper, in case the driving of the scanning part 120 and the paper feeding part 130 is initiated at the same time regarding the input of the copying instruction, an auditory indication that a copying job has started may be given to the user.

According to an example, the transfer of the printing paper by the paper feeding part 130 may be controlled to be completed before the scanning by the scanning part 120 is completed.

As the transfer of the printing paper by the paper feeding part 130 is initiated before the scanning by the scanning part 120 is completed, the stand-by time from the input of a printing instruction by the processor 140 into the image forming part 110 until the initiation of the image forming job decreases, and thus the total time from the input of the copying instruction to the output of the printing paper may be reduced.

According to an example, the transfer of the printing paper may be completed before the scanning of the document is completed, and thus the time of 0.5 seconds, which is a time spent until the paper ready state, may be reduced.

The processor 140 may control the image forming part 110 to perform at least one process among processes of the image forming job of the image forming part 110 while the scanning of the document by the scanning part 120 is in progress.

According to an example, the processor 140 may input a printing instruction into the image forming part 110 while the scanning of the document by the scanning part 120 is in progress and may control the image forming part 110 to initiate an exposure process of the exposure unit 113.

The memory 150 may store a minimum number of scan strips.

The minimum number of scan strips refers to a minimum number of strips for which scanning should be performed in the scanning part 120 to initiate an image forming job in the image forming part 110.

Based on scanning being performed in the scanning part 120 as much as the minimum number of scan strips stored in the memory and image data of the document being generated, the processor 140 may input a printing instruction into the image forming part 110, and control the image forming part 110 to perform at least one process among processes of the image forming job.

According to an example, the minimum number of scan strips may be stored as ten in the memory 150. Based on scanning of the ten strips being performed in the scanning part 120, the processor 140 may input a printing instruction including information on the scanned ten strips into the image forming part 110 and control the image forming part 110 to initiate an exposure process of the exposure unit 113.

In this case, the scanning and exposure processes for the remaining parts of the document may be performed at the same time, and the information on the strips scanned in the scanning part 120 may be transmitted to the image forming part 110 in real time. In that case, the image forming part 110 may perform an exposure process for the remaining parts of the document subsequently to the exposure process for the information on the ten strips initially input.

As the scanning job and the image forming job are performed at the same time, the total time from the input of the copying instruction to the output of the printing paper may be reduced.

According to an example, the exposure process of the exposure unit 113 may be initiated after a time of 1.45 seconds wherein the scanning of the ten strips is performed in the scanning part 120, and thus a time as much as 0.5 seconds, which is the time spent to scan the remaining parts of the document, may be reduced.

In case the processes of the image forming job are performed after scanning is performed as much as the minimum number of scan strips, the processor 140 may control the paper feeding part 130 to initiate transfer of a printing paper before the scanning as much as the minimum number of scan strips is performed in the scanning part 120.

According to an example, the processor 140 may control the paper feeding part 130 before the scanning of ten strips is performed in the scanning part 120 and initiate the transfer of the printing paper.

The memory 150 may store a standard scanning time, which is a time spent until scanning a part of a document.

The standard scanning time refers to a time to scan a part of a document in the scanning part 120 before initiating an image forming job in the image forming part 110. The standard scanning time may be set in consideration of an operation preparation time of the scanning part 120, the minimum number of scan strips, and a time spent to scan a strip. However, the disclosure is not limited thereto, and the standard scanning time may be selected experimentally.

Based on scanning being performed in the scanning part 120 as much as the standard scanning time stored in the memory and image data of the document being generated, the processor 140 may input a printing instruction into the image forming part 110, and control the image forming part 110 to perform at least one process among the processes of the image forming job.

According to an example, the standard time may be stored as 1.45 seconds in the memory 150. If scanning is performed during 1.45 seconds in the scanning part 120, the processor 140 may input a printing instruction including information on the document scanned for 1.45 seconds into the image forming part 110 and control the image forming part 110 to initiate the exposure process of the exposure unit 113.

In this case, as described above, the scanning job and the image forming job may be performed at the same time, and thus the total time from the input of the copying instruction to the output of the printing paper may be reduced.

According to an example, the exposure process of the exposure unit 113 may be initiated after a time of 1.45 seconds spent to scan a part of the document in the scanning part 120 passes, and thus a time as much as 0.5 seconds, which is a time spent to scan the remaining parts of the document, may be reduced.

In case the processes of the image forming job are performed after scanning is performed as much as the standard scanning time, the processor 140 may control the paper feeding part 130 to initiate the transfer of the printing paper before scanning is performed as much as the standard scanning time in the scanning part 120.

The minimum number of scan strips and the standard scanning time may be set such that the exposure process does not precede the scanning job, in consideration of the speed that the exposure process of the exposure unit 113 is performed, the speed of the document scanning job of the scanning part 120, and the size of the scanned document.

The memory 150 may store the preparation time spent for the ready state of the developing unit 111 and the entire scanning time spent for scanning the entire document of the scanning part 120.

The processor 140 may calculate a stand-by time wherein the preparation time was subtracted from the entire scanning time stored in the memory 150.

Based on a copying instruction being input, the processor 140 may control the scanning part 120 to initiate the scanning of the document, and after time passes as much as the stand-by time after the scanning was initiated, the processor 140 may control the image forming part 110 such that the driving of the developing unit 111 is initiated.

In case the driving of the developing unit 111 is initiated after time passes as much as the stand-by time after the scanning was initiated, the developing unit 111 may enter a ready state at the same time as the completion of the scanning for the entire document. In that case, an unnecessary idling time of the developing unit 111 may be reduced and unnecessary reduction of the lifespan of the developing unit 111 may be prevented.

According to an example, if the preparation time spent for the ready state of the developing unit 111 is 1 second, and the time spent for scanning the entire document by the scanning part 120 is 1.95 seconds, the stand-by time becomes 0.95 second.

According to an example, based on a copying instruction being input, the processor 140 may control the scanning part 120, and, based on a time of 0.95 seconds passing, the processor 140 may control the image forming part 110 to initiate the preparation operation of the developing unit 111.

According to an example, in case the processor 140 controls the image forming part 110 to perform the image forming job while the scanning of the document by the scanning part 120 is in progress, the stand-by time may be a time wherein the preparation time was subtracted from the time spent for performing scanning as much as the minimum number of scan strips. Alternatively, the stand-by time may be a time wherein the preparation time was subtracted from the standard scanning time.

According to an example, in case the time spent for performing scanning as many as ten strips is 1.45 seconds, and the preparation time is 1 second, the stand-by time may be 0.45 seconds. In this case, based on a copying instruction being input, the processor 140 may control the scanning part 120, and, based on a time of 0.45 seconds passing, the processor 140 may control the image forming part 110 to initiate the preparation operation of the developing unit 111.

According to an example, in case scanning is performed as much as the minimum number of scan strips or the processor 140 inputs a printing instruction into the image forming part 110 after the standard scanning time passes, the developing unit 111 may enter a ready state. In that case, the image forming part 110 may perform the processes of the image forming job immediately after receiving the printing instruction.

The memory 150 may store information on a fixing temperature of the fixing unit 112.

The information on the fixing temperature may include information on a minimum fixing temperature at which the fixing process can be performed, and a rising speed of the temperature of the heat source included in the fixing unit 112. However, the disclosure is not limited thereto.

The processor 140 may select whether to initiate driving of the developing unit 111 by detecting the temperature of the fixing unit 112 before initiating the driving of the developing unit 111.

The processor 140 may set the fixing temperature such that the temperature of the fixing unit 112 reaches the minimum fixing temperature based on the developing unit 111 initiating driving and reaching a ready state, in consideration of the time spent for reaching the ready state of the developing unit 111, the minimum fixing temperature of the fixing unit 112, and the rising speed of the temperature of the heat source.

As an example, the fixing temperature may be set by subtracting a value obtained by multiplying the rising speed of the temperature of the heat source and the time spent for reaching the ready state of the developing unit 111 from the minimum fixing temperature of the fixing unit 112.

As an example, in case the minimum fixing temperature is 140° C., the rising speed of the temperature is 10° C./s, and the time spent for reaching the ready state of the developing unit 111 is 1 second, the fixing temperature may be set as 140° C.−10° C./s*1 second=130° C. If the driving of the developing unit 111 is initiated based on the temperature of the fixing unit 112 being 130° C. or higher, based on the developing unit 111 becoming a ready state, the temperature of the fixing unit 112 becomes 140° C. which is the minimum fixing temperature or higher.

The processor 140 may detect the temperature of the fixing unit 112 before initiating the driving of the developing unit 111, and control the image forming part 110 to initiate the driving of the developing unit 111 in case the temperature of the fixing unit 112 is the fixing temperature or higher.

According to an example, a phenomenon wherein the developing unit 111 is driven according to an input of a copying instruction and makes an unnecessary idling even though the temperature of the fixing unit 112 did not reach the fixing temperature can be prevented. In that case, unnecessary reduction of the lifespan of the developing unit 111 can be prevented.

The image forming apparatus 100 may include a paper discharging part for normal printing output and an additional paper discharging part.

The paper discharging part for normal printing output refers to a paper discharging part wherein a printing paper for which an image forming job was completed is discharged based on the image forming job being performed normally without an error.

As transfer of a printing paper by the paper feeding part 130 is initiated before scanning of a document by the scanning part 120 is completed, in case the scanning of the document failed or the feeding of the paper by the ADF failed and the image forming job cannot be completed, the printing paper of which transfer was initiated should be discharged to the paper discharging part.

According to an example, if a printing instruction is not generated until a time point after a copying instruction is input, the processor 140 may control the image forming apparatus 100 to discharge the transferred paper. Also, if the scanning by the scanning part 120 is not completed normally even after generation of a printing instruction by the processor 140, the processor 140 may control the image forming apparatus 100 to discharge the transferred paper.

In this case, if the printing paper is discharged to the paper discharging part for normal printing output, printing papers that were normally output and printing papers of which image forming job was not completed may get mixed. To prevent this, an additional paper discharging part may be further included. In that case, the processor 140 may discharge the printing paper of which an image forming job was not completed to the additional paper discharging part, and therefore classify the papers that were normally output and the papers of which an image forming job was not completed.

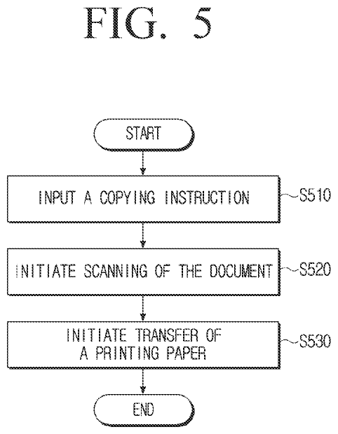

FIG. 5 is a flow chart illustrating a processing method of a document of an image forming apparatus according to an example.

Referring to FIG. 5, a processing method of a document of an image forming apparatus may include an operation S510 wherein a copying instruction for a document is input, an operation S520 wherein scanning of the document is initiated, and an operation S530 wherein transfer of a printing paper is initiated before the scanning of the document is completed.

As the timing of transferring a printing paper was described in the aforementioned parts, an overlapping explanation will be omitted.

In a state wherein the scanning of the document was initiated at operation S520 and the scanning is in progress, at least one process among processes of the image forming job may be performed at the same time. As the content of performing scanning of the document and the image forming job at the same time was described in the aforementioned parts, an overlapping explanation will be omitted.

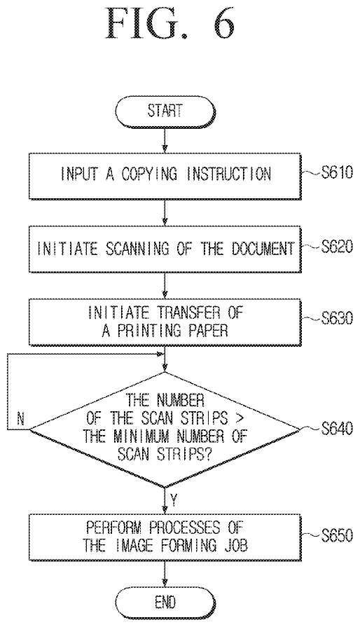

FIG. 6 to FIG. 9 are flow charts illustrating a processing method of a document of an image forming apparatus according to various examples.

According to FIG. 6, a processing method of a document of an image forming apparatus may include an operation S610 wherein a copying instruction for a document is input, an operation S620 wherein scanning of the document is initiated, and an operation S630 wherein transfer of a printing paper is initiated. Also, the transfer of the printing paper may be initiated before the scanning of the document is performed as much as the minimum number of scan strips. For example, in operation S640, it may be detected whether the scanning of the document being is performed as much as the minimum number of scan strips. In that case, an operation S650 of performing at least one process among the processes of the image forming job may be performed.

As the contents related to the minimum number of scan strips and the simultaneous performing of the scanning of the document and the image forming job were described above, an overlapping explanation will be omitted.

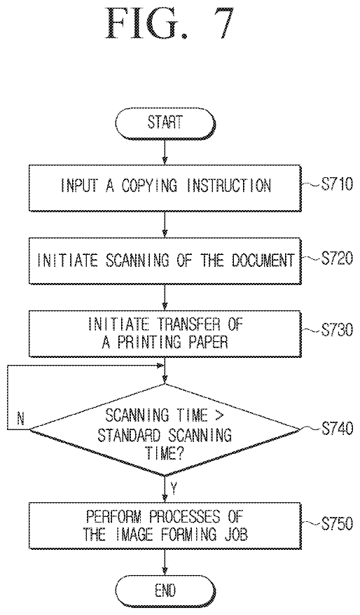

According to FIG. 7, operations S710, S720, and S730 are substantially the same as operations S610, S620, and S630 described above such that an overlapping explanation will be omitted. In a processing method of a document of an image forming apparatus, before the scanning time passes the standard scanning time in operation S740, transfer of a printing paper may be initiated in operation S730, and after the scanning time passed the standard scanning time, at least one process among the processes of the image forming job may be performed in operation S750.

As the content related to the standard scanning time was described above, an overlapping explanation will be omitted.

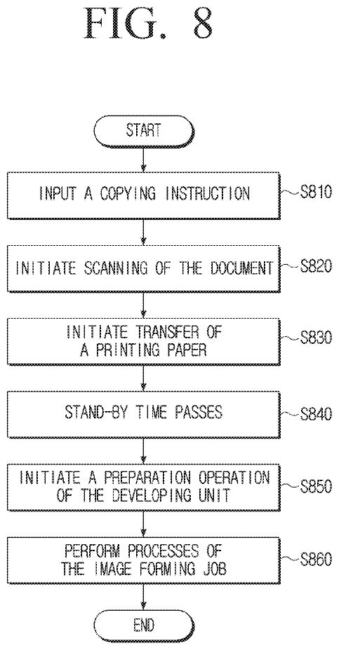

According to FIG. 8, in a processing method of a document of an image forming apparatus, a copying instruction for a document may be input in operation S810, scanning of the document may be initiated in operation S820, and transfer of a printing paper may be initiated in operation S830. However, based on the stand-by time passing after the scanning was initiated in operation S840, a preparation operation of the developing unit may be initiated in operation S850, and, according to the degree of the scanning of the document, at least one process among the processes of the image forming job may be performed in operation S860.

The stand-by time may be a time wherein the preparation time of the developing unit was subtracted from the entire scanning time. Because the contents related to the stand-by time, the transfer of the printing paper, and the driving of the developing unit were described above, an overlapping explanation will be omitted.

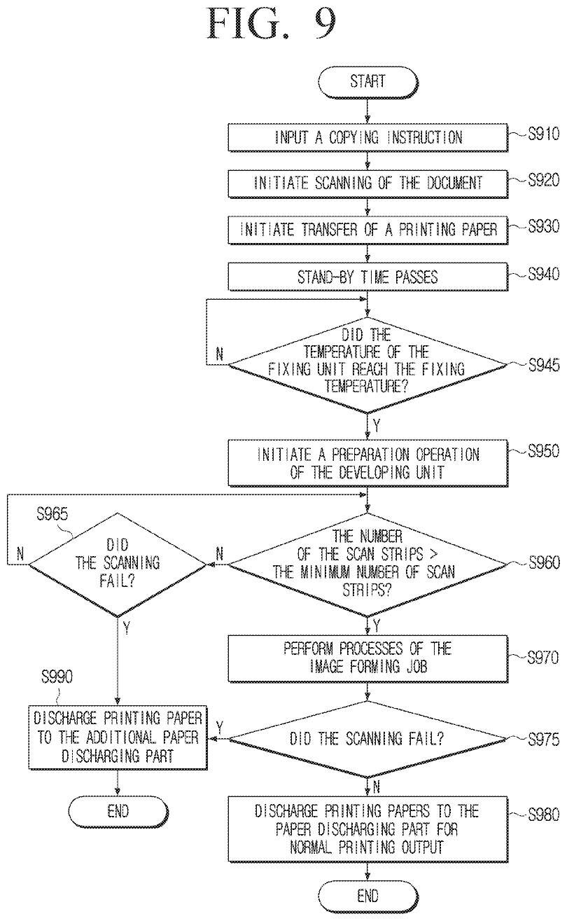

According to FIG. 9, in a processing method of a document of an image forming apparatus, a copying instruction for a document may be input in operation S910, scanning of the document may be initiated in operation S920, and transfer of a printing paper may be initiated in operation S930. After the stand-by time passes in operation S940, it may be identified whether the temperature of the fixing unit reached the fixing temperature in operation S945, and, in case the temperature of the fixing unit reached the fixing temperature, a preparation operation of the developing unit may be initiated in operation S950.

After the scanning of the document was initiated in operation S920, if the scanning is performed in greater than or equal to the minimum number of scan strips in operation S960, at least one process among the processes of the image forming job may be performed in operation S970.

After the transfer of the printing paper was initiated in operation S930, if the scanning is not performed in greater than or equal to the minimum number of scan strips in operation S960, and the scanning fails in operation S965, printing papers of which an image forming job was not completed may be discharged to the additional paper discharging part distinguished from the paper discharging part for normal printing output in operation S990.

Also, in case the scanning is performed in greater than or equal to the minimum number of scan strips in operation S960, and after the processes of the image forming job were initiated at the same time in operation S970, based on the scanning of the document failing in operation S975, as the image forming job cannot be completed, printing papers of which an image forming job was not completed may be discharged to the additional paper discharging part in operation S990.

In case the scanning is completed normally in operation S975 and the processes of the image forming job are completed normally, the printing papers of which an image forming job was completed may be discharged to the paper discharging part for normal printing output in operation S980.

As the contents related to the fixing temperature of the fixing unit, the minimum number of scan strips, failure of the image forming job, and the paper discharging parts were described above, an overlapping explanation will be omitted.

The aforementioned examples may be implemented in a form of a non-transitory computer-readable recording medium that can be read by a computer storing instructions and data executable by a computer. At least one of the instructions or the data may be stored in a form of a program code, and, based on executing the instructions or the data by a processor, the instructions or the data may generate a specific program module and perform a specific operation.

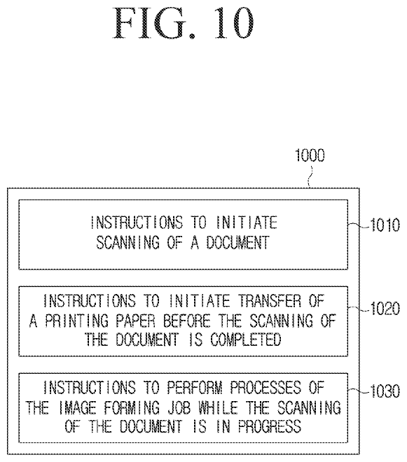

FIG. 10 is a diagram illustrating instructions stored in a non-transitory computer-readable recording medium according to an example.

A non-transitory computer-readable recording medium 1000 may store instructions (e.g., program codes) related to the aforementioned example operations of the image forming apparatus.

According to an example, the non-transitory computer-readable recording medium 1000 may include an instruction 1010 to initiate scanning of a document based on a copying instruction for the document being input, an instruction 1020 to initiate transfer of a printing paper before the scanning of the document is completed, and an instruction 1030 to perform at least one process among processes of the image forming job while the scanning of the document is in progress.

As the content related to the processes of the image forming job was described above, an overlapping explanation will be omitted.

Each instruction may be manufactured in a program language in various forms and recorded. Also, each instruction may be combined as at least one, and stored in a non-transitory recording medium in a form of machine readable instructions.

Such a non-transitory computer-readable recording medium may include a read-only memory (ROM), a random-access memory (RAM), a flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, a magnetic tape, a floppy disk, a magneto-optical data storage apparatus, an optical data storage apparatus, a hard disk, a solid-state disk (SSD), and machine readable instructions, related data, data files, and data structures. Also, the computer-readable recording medium may be any apparatus that can provide machine readable instructions, related data, data files, and data structures to a processor or a computer so that the processor or the computer can execute the instructions.

While examples of the disclosure have been shown and described, the disclosure is not limited to the aforementioned examples, and it is apparent that various modifications can be made without departing from the gist of the disclosure as claimed by the appended claims, and such modifications are within the scope of the descriptions of the claims.

What is claimed is:

1. An image forming apparatus comprising:
an image forming part;
a paper feeding part to transfer a printing paper to the image forming part;
a scanning part; and
a processor, wherein the processor is to, based on a copying instruction of a document being input, control the scanning part to initiate scanning for the document to be copied, and control the paper feeding part to initiate transfer of the printing paper before the scanning is completed.

2. The image forming apparatus of claim 1,
wherein the processor is to control the image forming part to perform at least one process among processes of an image forming job performed by the image forming part while the scanning of the document is in progress, and
wherein the processes of the image forming job include at least one of a charging process of charging a photosensitive body, an exposure process of forming a latent image on the photosensitive body, a developing process of developing the latent image into an image, a transfer process of transferring the image to the printing paper, or a fixing process of fixing the image transferred to the printing paper.

3. The image forming apparatus of claim 2, further comprising:
a memory to store a minimum number of scan strips,
wherein the processor is to:
control the paper feeding part to initiate the transfer of the printing paper before scanning is performed in the scanning part as much as the minimum number of scan strips stored in the memory, and
based on the scanning being performed as much as the minimum number of scan strips in the scanning part, control the image forming part to perform the at least one process.

4. The image forming apparatus of claim 2, further comprising:
a memory to store a standard scanning time which is a time spent until scanning a part of a document,
wherein the processor is to:
control the paper feeding part to initiate the transfer of the printing paper before the standard scanning time stored in the memory passes after the scanning was initiated in the scanning part, and
based on the standard scanning time passing, control the image forming part to perform the at least one process.

5. The image forming apparatus of claim 2, further comprising:
a memory to store information on a preparation time of a developing unit to perform the developing process and an entire scanning time,
wherein the processor is to, based on a stand-by time passing after the scanning was initiated in the scanning part, control the image forming part to initiate a preparing operation of the developing unit, and
wherein the stand-by time includes a time in which the preparation time was subtracted from the entire scanning time.

6. The image forming apparatus of claim 2, further comprising:
a memory to store information on a fixing temperature of a fixing unit performing the fixing process,
wherein the processor is to, based on the temperature of the fixing unit reaching the fixing temperature after the scanning was initiated in the scanning part, control the image forming part to initiate a preparing operation of the developing unit.

7. The image forming apparatus of claim 1, further comprising:
an additional paper discharging part distinguished from a paper discharging part for normal printing output,
wherein the processor is to, based on the scanning of the document failing after the transfer of the printing paper was initiated, discharge the printing paper to the additional paper discharging part.

8. A processing method of a document of an image forming apparatus, the processing method comprising:
based on a copying instruction of a document being input, initiating scanning of the document; and
initiating transfer of a printing paper before the scanning of the document is completed.

9. The processing method of claim 8, further comprising:
performing at least one process among processes of an image forming job while the scanning of the document is in progress,
wherein the processes of the image forming job include at least one of a charging process of charging a photosensitive body, an exposure process of forming a latent image on the photosensitive body, a developing process of developing the latent image into an image, a transfer process of transferring the image to the printing paper, or a fixing process of fixing the image transferred to the printing paper.

10. The processing method of claim 9,
wherein the transfer of the printing paper is initiated before the scanning of the document is performed as much as the minimum number of scan strips, and
wherein the at least one process is performed after the scanning of the document was performed as much as the minimum number of scan strips.

11. The processing method of claim 9,
wherein the transfer of the printing paper is initiated before a standard scanning time passes after the scanning was initiated,
wherein the at least one process is performed after the standard scanning time passed, and
wherein the standard scanning time is a time spent until scanning a part of a document.

12. The processing method of claim 9, further comprising:
based on a stand-by time passing after the scanning was initiated, initiating a preparing operation of a developing unit, and
wherein the stand-by time is a time in which a preparation time of the developing unit was subtracted from an entire scanning time.

13. The processing method of claim 9, further comprising:
based on a temperature of a fixing unit reaching a fixing temperature after the scanning was initiated, initiating a preparing operation of the developing unit.

14. The processing method of claim 8, further comprising:
based on the scanning of the document failing after the transfer of the printing paper was initiated, discharging the printing paper to an additional paper discharging part distinguished from a paper discharging part for normal printing output.

15. A non-transitory recording medium storing instructions for performing a processing method of a document of an image forming apparatus, the non-transitory recording medium comprising:
instructions to, based on a copying instruction of a document being input, initiate scanning of a document;
instructions to initiate transfer of the printing paper before the scanning of the document is completed; and
instructions to perform at least one process among processes of an image forming job while the scanning of the document is in progress,
wherein the processes of the image forming job include at least one of a charging process of charging a photosensitive body, an exposure process of forming a latent image on the photosensitive body, a developing process of developing the latent image into an image, a transfer process of transferring the image to the printing paper, or a fixing process of fixing the image transferred to the printing paper.
